(19) United States
(12) Patent Application Publication
(10) Pub. No.: US 2018/0043633 A1
(43) Pub. Date: Feb. 15, 2018

(54) SYSTEM FOR PRINTING AN OBJECT AND A METHOD FOR PRINTING AN OBJECT

(71) Applicant: City University of Hong Kong, Kowloon (HK)

(72) Inventors: Kening Zhu, New Territories (HK); Alexandru Dancu, Goteburg (SE); Shengdong Zhao, Singapore (SG)

(21) Appl. No.: 15/233,469

(22) Filed: Aug. 10, 2016

(51) Int. Cl. B29C 67/00; B33Y 30/00; B29C 71/04; B33Y 10/00

(52) U.S. Cl. CPC B29C 67/0088; B29C 67/007; B33Y 10/00; B33Y 30/00; B29C 71/04; B29K 2105/0058

(57) ABSTRACT

A system and a method for printing an object includes a display module arranged to display a two-dimensional representation within a two-dimensional space, the two-dimensional representation being arranged to represent a two-dimensional view of a three-dimensional object within the two-dimensional space; a processing module arranged to transform the two-dimensional representation into a plurality of two-dimensional expressions arranged to individually represent a portion of the three-dimensional object; and a printing module arranged to form the three-dimensional object from a fluid medium arranged to transform its physical state in response to a manipulated illumination exposed thereto, wherein the manipulated illumination exposed to the fluid medium is associated with the plurality of two-dimensional expressions disposed therebetween, and with the inner surface of the printed three-dimensional object being arranged to match the outer surface of a real-world object inserted therein.

### TECHNICAL FIELD

The present invention relates to a system for printing an object and a method for printing an object, and particularly, although not exclusively, to a system for printing an object matched with an inserted physical object and a method for printing an object matched with an inserted physical object.

### BACKGROUND

Typical optical devices such as projectors are deployed for projecting an image onto a surface. The projectors create an image by shining a light from an incandescent light bulb through a small transparent lens to a display, or alternatively directing the light to a human retina. The brightness of the image presented on the display depends on the ambient light level and luminous power of the light bulb.

In an optical arrangement, the projector and the display are spaced from each other for a minimum projection distance. For example, the projector may be disposed in a direction away from the display i.e. increasing the projection distance to serve as an enlarger, thereby magnifying the image to be displayed. The same amount of light is spread over a larger screen, resulting in a dimmer image throughout the illumination. The projector may thereby provide visual information of an object viewing from one of the views within the three-dimensional space.

### SUMMARY OF THE INVENTION

In accordance with a first aspect of the present invention, there is provided a method for printing an object comprising the steps of: displaying a two-dimensional representation within a two-dimensional space, wherein the two-dimensional representation is arranged to represent a two-dimensional view of a three-dimensional object within the two-dimensional space; transforming the two-dimensional representation into a plurality of two-dimensional expressions arranged to individually represent a portion of the three-dimensional object; forming the three-dimensional object from a fluid medium arranged to transform its physical state in response to a manipulated illumination exposed thereto, wherein the manipulated illumination exposed to the fluid medium is associated with the plurality of two-dimensional expressions disposed therebetween, and with the inner surface of the printed three-dimensional object being arranged to match the outer surface of a real-world object inserted therein.

In an embodiment of the first aspect, each of the represented portions of the three-dimensional object are evenly spaced along at least one of the X, Y and Z axis of the three-dimensional object.

In an embodiment of the first aspect, the two-dimensional representation includes a sketch displayed on a design interface.

In an embodiment of the first aspect, the sketch includes at least one sketched line.

In an embodiment of the first aspect, the sketch further includes at least one additional sketched line associated with the inserting location of the real-world object.

In an embodiment of the first aspect, the plurality of two-dimensional expressions includes a plurality of slides.

In an embodiment of the first aspect, the method further comprises the step of transforming the sketch into a plurality of slides.

In an embodiment of the first aspect, the method further comprises the step of shining the plurality of slides to cure a photo-reactive resin thereby forming the three-dimensional object layer by layer.

In an embodiment of the first aspect, the plurality of slides are shined in sequence by a light source to cure the photo-reactive resin gradually.

In an embodiment of the first aspect, the thickness of the three-dimensional object layer is manipulated by the light intensity of the light source, the length of exposure under the light source and/or the colour of the slides.

In an embodiment of the first aspect, an additional slide is shined by a projector to pause the curing of the photo-reactive resin.

In an embodiment of the first aspect, the method further comprises the step of inserting the real-world object or a mold of the real-world object into the photo-reactive resin during the step of printing.

In an embodiment of the first aspect, the real-world object or the mold of the real-world object is inserted into the photo-reactive resin when the curing is paused.

In an embodiment of the first aspect, the photo-reactive resin includes flexible silicon arranged to facilitate the removal of the printed three-dimensional object.

In an embodiment of the first aspect, the method further comprises the step of post-processing the printed three-dimensional object.

In an embodiment of the first aspect, the printed three-dimensional object is arranged to undergo a surface treatment.

In an embodiment of the first aspect, the surface treatment includes UV exposure and/or sanding.

In an embodiment of the first aspect, the method further comprises the step of mixing the photo-reactive resin with conductive gel prior to the shining step such that the formed three-dimensional object is conductive.

In an embodiment of the first aspect, the conductivity and touch sensitivity of the conductive three-dimensional object is associated with the ratio of conductive gel to photo-reactive resin, and/or the shape of the object.

In an embodiment of the first aspect, the real-world object includes a complex geometric structure.

In accordance with a second aspect of the present invention, there is provided a system for printing an object, comprising: a display module arranged to display a two-dimensional representation within a two-dimensional space, wherein the two-dimensional representation is arranged to represent a two-dimensional view of a three-dimensional object within the two-dimensional space; a processing module arranged to transform the two-dimensional representation into a plurality of two-dimensional expressions arranged to individually represent a portion of the three-dimensional object; a printing module arranged to form the three-dimensional object from a fluid medium arranged to transform its physical state in response to a manipulated illumination exposed thereto, wherein the manipulated illumination exposed to the fluid medium is associated with the plurality of two-dimensional expressions disposed therebetween, and with the inner surface of the printed three-dimensional object being arranged to match the outer surface of a real-world object inserted therein.

In an embodiment of the second aspect, each of the represented portions of the three-dimensional object are evenly spaced along at least one of the X, Y and Z axis of the three-dimensional object.

In an embodiment of the second aspect, the two-dimensional representation includes a sketch displayed on a design interface of the display module.

In an embodiment of the second aspect, the sketch includes at least one sketched line.

In an embodiment of the second aspect, the sketch further includes at least one additional sketched line associated with the inserting location of the real-world object.

In an embodiment of the second aspect, the plurality of two-dimensional expressions includes a plurality of slides.

In an embodiment of the second aspect, the processing module transforms the sketch into a plurality of slides.

In an embodiment of the second aspect, the plurality of slides are shined to cure a photo-reactive resin thereby forming the three-dimensional object layer by layer.

In an embodiment of the second aspect, the plurality of slides are shined in sequence by a light source to cure the photo-reactive resin gradually.

In an embodiment of the second aspect, the thickness of the three-dimensional object layer is manipulated by the light intensity of the light source, the length of exposure under the light source and/or the colour of the slides.

In an embodiment of the second aspect, an additional slide is shined by a projector to pause the curing of the photo-reactive resin.

In an embodiment of the second aspect, the real-world object or a mold of the real-world object is inserted into the photo-reactive resin during the printing.

In an embodiment of the second aspect, the real-world object or the mold of the real-world object is inserted into the photo-reactive resin when the curing is paused.

In an embodiment of the second aspect, the photo-reactive resin includes flexible silicon arranged to facilitate the removal of the printed three-dimensional object.

In an embodiment of the second aspect, the printed three-dimensional object is further post-processed.

In an embodiment of the second aspect, the printed three-dimensional object is arranged to undergo a surface treatment.

In an embodiment of the second aspect, the surface treatment includes UV exposure and/or sanding.

In an embodiment of the second aspect, the photo-reactive resin is mixed with conductive gel prior to shining such that the formed three-dimensional object is conductive.

In an embodiment of the second aspect, the conductivity and touch sensitivity of the conductive three-dimensional object is associated with the ratio of conductive gel to photo-reactive resin, and/or the shape of the object.

In an embodiment of the second aspect, the real-world object includes a complex geometric structure.

### BRIEF DESCRIPTION OF THE DRAWINGS

Embodiments of the present invention will now be described, by way of example, with reference to the accompanying drawings in which:

FIG. 1 is an illustration showing the display module in accordance with one embodiment of the present invention;

FIG. 2 is an illustration showing the printing module in accordance with one embodiment of the present invention;

FIGS. 3(A), 3(B), 3(C), 3(D), 3(E), 3(F), and 3(H) are illustrations showing the steps for designing an object within the sketch interface in accordance with one embodiment of the present invention;

FIG. 4 is an illustration showing the steps of printing an object in accordance with one embodiment of the present invention;

FIG. 5 is an illustration showing the physical object placed in the resin during the printing operation in accordance with one embodiment of the present invention;

FIG. 6(A) is an illustration showing the pen inserted to the printed penholder in accordance with one embodiment of the present invention;

FIG. 6(B) is an illustration showing the bottom surface of the pen inserted to the printed penholder in accordance with one embodiment of the present invention;

FIG. 6(C) is an illustration showing the detailed patterns on the bottom surface of the pen are engraved within the inner surface of the printed penholder in accordance with one embodiment of the present invention;

FIG. 7 is an illustration showing the post-processing module in accordance with one embodiment of the present invention;

FIG. 8 is a schematic diagram showing the overall process of the system in accordance with one embodiment of the present invention;

FIG. 9(A) is an illustration showing a mold wrapped around a finger in accordance with one embodiment of the present invention;

FIG. 9(B) is an illustration showing a mold placed in the resin in accordance with one embodiment of the present invention;

FIG. 9(C) is an illustration showing a printed ring in accordance with one embodiment of the present invention;

FIG. 9(D) is an illustration showing the printed ring fitted with the finger in accordance with one embodiment of the present invention;

FIG. 10(A) is an illustration showing a screw placed in the resin in accordance with one embodiment of the present invention;

FIG. 10(B) is an illustration showing a printed object with internal threads fitted with the outer surface of the screw in accordance with one embodiment of the present invention;

FIG. 11(A) is an illustration showing an assembly structure with a printed part in accordance with one embodiment of the present invention;

FIG. 11(B) is an illustration showing an assembly structure with a printed part mounted to a wall in accordance with one embodiment of the present invention;

FIG. 11(C) is an illustration showing an assembly structure with a printed part for hanging clothes in accordance with one embodiment of the present invention;

FIG. 12(A) is an illustration showing the toy placed in the resin in accordance with one embodiment of the present invention;

FIG. 12(B) is an illustration showing the toy with printed part in accordance with one embodiment of the present invention;

FIG. 12(C) is an illustration showing another toy with printed part in accordance with one embodiment of the present invention;

FIG. 12(D) is an illustration showing printed part swapped between two toys in accordance with one embodiment of the present invention;

FIG. 13(A) is an illustration showing the plastic bottle placed in the resin in accordance with one embodiment of the present invention;

FIG. 13(B) is an illustration showing the printed plastic cap with internal threads fitted with the outer surface of the bottle opening in accordance with one embodiment of the present invention;

FIG. 14(A) is an illustration showing the sketch of a stand with the aiding of the smart phone in accordance with one embodiment of the present invention;

FIG. 14(B) is an illustration showing the perspective view of a stand with the smart phone inserted in accordance with one embodiment of the present invention;

FIG. 15(A) is an illustration showing the steps of printing a solid sphere in accordance with one embodiment of the present invention;

FIG. 15(B) is an illustration showing the printed solid sphere in accordance with one embodiment of the present invention;

FIG. 16 is an illustration showing a printed touch sensor in accordance with one embodiment of the present invention;

FIG. 17 is an illustration showing a plurality of printed touch sensors in different shapes in accordance with one embodiment of the present invention;

FIG. 18(A) is an illustration showing a printed touch sensor attached to a pair of glasses in accordance with one embodiment of the present invention;

FIG. 18(B) is an illustration showing a pair of glasses with a printed touch sensor attached worn by a user in accordance with one embodiment of the present invention;

FIG. 19 is a graph showing the thickness of the printed object against the colour of projected pattern with different cure duration in accordance with one embodiment of the present invention; and

FIG. 20 is a graph showing the electric resistance against the ratio of conductive gel and resin of printed object with different shapes in accordance with one embodiment of the present invention.

### DETAILED DESCRIPTION OF THE PREFERRED EMBODIMENT

The inventors have, through their own research, trials and experiments, devised that a low cost stereolithography-based rapid prototyping printing technique allows high-precision fabrication without high-end modelling tools. Advantageously, by mixing everyday physical artifacts with photo-reactive resin and preferably with the addition of liquid conductive gels during the printing process, this advanced technique facilitates the creation of objects that perfectly fit the existing physical objects without any accurate scanning or modelling tools or tolerance adjustment in the hardware.

In one example embodiment of the present invention, there is provided a design interface allowing users to design the printed shapes using physical objects as references, a processing module to generate projection patterns from the sketches, and a printing module notifies the user when to place the physical objects in the resin during the printing process. Optionally, the present invention further provides a post-processing unit for surface treating the printed object to enhance the product finishing.

Advantageously, the user may be highly engaged with the overall fabrication process. The present invention allows the user to get involved not only the design stage but from the design stage to the printing stage, thereby allows a rapid prototyping of any innovative concepts.

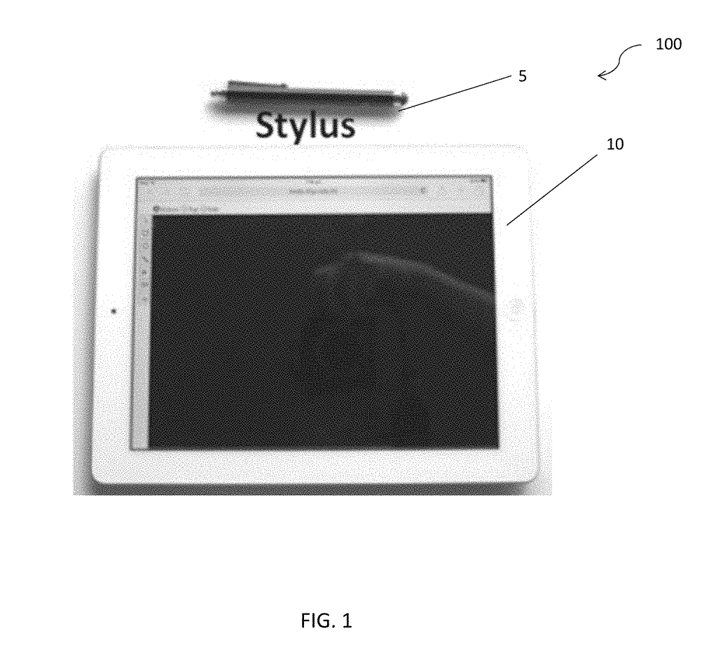

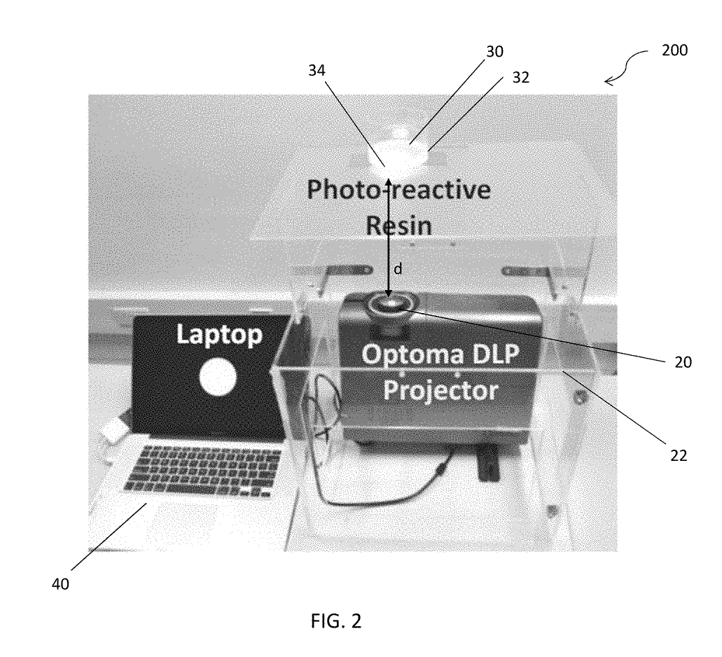

With reference to FIGS. 1 to 2, there is provided an example embodiment of a system 1 for printing an object, comprising: a display module 100 arranged to display a two-dimensional representation within a two-dimensional space, wherein the two-dimensional representation is arranged to represent a two-dimensional view of a three-dimensional object within the two-dimensional space; a processing module 150 (not shown) arranged to transform the two-dimensional representation into a plurality of two-dimensional expressions arranged to individually represent a portion of the three-dimensional object; a printing module 200 arranged to form the three-dimensional object from a fluid medium 30 arranged to transform its physical state in response to a manipulated illumination exposed thereto, wherein the manipulated illumination exposed to the fluid medium 30 is associated with the plurality of two-dimensional expressions disposed therebetween, and with the inner surface of the printed three-dimensional object being arranged to match the outer surface of a real-world object 80 inserted therein.

In this embodiment, the display module 100 comprises a display 10 or a mobile tablet with a design interface 10 for shape designing, and a processing module 150 for transforming a two dimensional representation into a plurality two-dimensional expressions for representing a three-dimensional object. A two-dimensional representation is designed in the form of sketch for displaying within a two-dimensional space. The sketch may be formed by at least one sketched line, or a plurality of sketched lines drawn by a user, for example using a stylus 5. It will be appreciated by persons skilled in the art that the line may be sketched on a touch screen 10 with user's fingers or any other drawing tools.

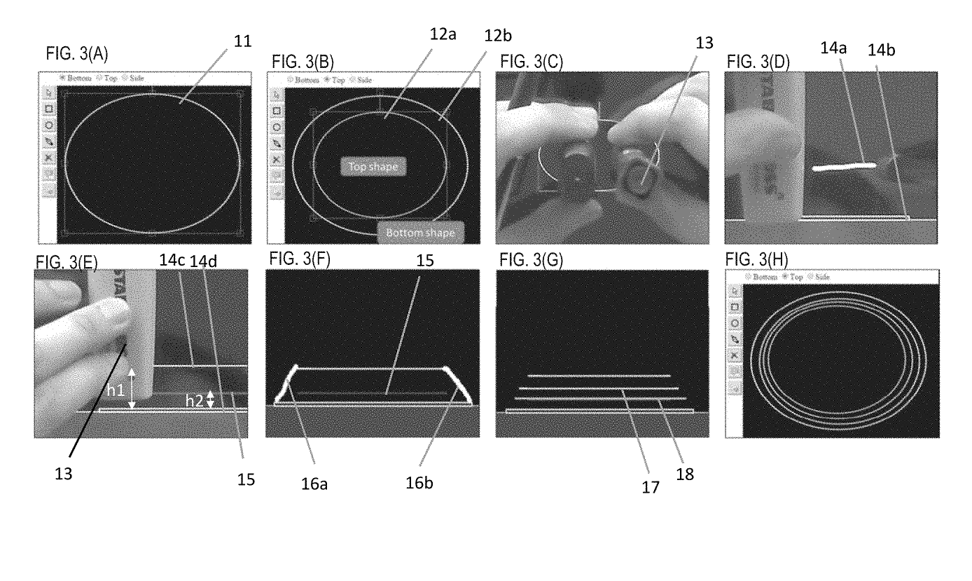

With reference to FIGS. 3(A), 3(B), 3(C), 3(D), 3(E), 3(F), and 3(H), there is shown an example embodiment showing the steps for designing a print object 80 e.g. a penholder 80, and transforming the design into a plurality of slides 17 (as shown in FIG. 3(G)) for printing. These slides 17 each present a portion of the object and are evenly spaced along at least one of the X, Y and Z axis of the printed object 80.

In this example embodiment, the user first draw the bottom shape of an object, such as basic shape drawings and freehand drawings in the canvas of the design interface 10 as shown in the sketch 11 of FIG. 3(A). The user activates the canvas in the top view where the processing module 150 automatically creates two cloned sketches 12a and 12b of the sketch 11 in the bottom view, one for editing and the other for reference. For example, the user may resize the top shape sketch 12a with reference to the bottom shape sketch 12b.

Advantageously, a physical object 13 e.g. a pen 13, may be placed on top of the sketch interface 10 to assist the user to adjust the shapes represented by the sketches 12a and 12b, thereby ensuring the three-dimensional object designed may accommodate the physical object 13 as shown in FIG. 3(B). For example, the user may employ two marker pens to assist him in resizing the shape of the penholder sketch, to ensure the printed penholder 80 have enough space for receiving the stationaries 13.

With reference now to FIG. 3(D), the design interface 10 may now switch to the side view where the user may design the height of the penholder 80. For example, the user may draw two strokes 14a and 14b to indicate the bottom and the top of the penholder 80 as shown in FIG. 3(D), and the processing module 150 may generates two straight lines 14c and 14d based on the size of the shapes in bottom and top views represented by sketches 12a-12b and the positions of the two strokes 14a-14b drawn by the user as shown in FIG. 3(E). The vertical distance between the two straight lines 14c and 14d indicates the height h1 of the penholder 80. Advantageously, the user may design the height of the penholder 80 with the aiding of the pen 13.

Preferably, the sketch may further include at least one additional sketched line 15 associated with the inserting location of the pen 13. With reference to FIG. 3(E), the display interface 10 may further allow the user to draw an additional sketch line 15 between the two strokes 14c and 14d, thereby indicating the location of the pen 13 to be inserted. For example, the pen 13 may be placed on top of the sketch interface 10 again to assist the user to draw the sketch line 15, in order to determine the height of the object to be placed h2 with reference to the bottom of the penholder 80, as shown in FIG. 3(E).

Optionally, the sketch line 15 may be presented in other colours, e.g. red to contrast from the other sketches in the sketch interface 10. It will be appreciated by persons skilled in the art that multiple sketch lines may be used to indicate the insertion of a plurality of physical objects 13.

With reference to FIG. 3(F), upon the heights of the object h1 and location for the insertion of the pen h2 have been defined, the user may then design the slopes of the penholder 80 by sketching two sketches 16a and 16b to connect between the bottom and top lines 14c and 14d. The processing module 150 may then analyse the design and calculate the number of interval layers 17 that are needed to be printed based on the design of the slope 16a and 16b and the height h1, thereby generating a plurality of two dimensional expressions 17, preferably in the form of slides 17 between the bottom and top lines 14c-14d, as shown in FIG. 3(G).

In this example embodiment, the processing module 150 may generates one interval layer in a desirable thickness, e.g. every 2 mm between the bottom and top lines 14c and 14d. Advantageously, an additional slide 18 is formed between the bottom and top lines 14c-14d as shown in FIG. 3(G), for representing a layer corresponding to the sketch line 15 shown on the side view in FIG. 3(F) and indicating the location of the pen 13 to be inserted.

The plurality of slides 17, each individually represent a portion of the penholder 80 viewed from the top as shown in FIG. 3(H). The shape in each slide 17 is scaled according to its distance from the bottom line 14d. The processing module 150 may further converts the modelled object into a sequence of slides 17, and automatically set the duration in which each slide 17 will be projected under a light source 20 of the printing module 200.

With reference to FIG. 2, the printing module 200 comprises a light source 20, a fluid medium 30, and a computer 40. The light source 20 may be a projector 20. Preferably, the fluid medium 30 is a photo-reactive resin 30 filled within a container 32. Optionally, the light source 20 may be disposed within a transparent case 22, e.g. an acrylic case 22, and preferably projected upward to the container 32 disposed on the acrylic case 22 thereby providing a manipulated illumination to shine and cure the photo-reactive resin 30. It will be appreciated by persons skilled in the art that the light source 20 may be projected in any directions to provide illumination to the resin 30 without the transparent cases 22. Preferably, the maximum illumination is achieved by a minimum project distance d of the light source 20 from the resin container 32.

Optionally, the base of the resin 30 may be made of flexible silicon 34 for facilitating the easy-removal of the printed object from the container 32 for post-processing.

In this embodiment, the plurality of slides 17 obtained from the processing module 150 are projected through the light source 20 to the resin 30 in a desired sequence for curing the resin 30 layer by layer, thereby forming the designed object in the design module 100 layer by layer. The thickness of each layer is manipulated by the illumination through the intensity of the light source 20 and the duration in which the resin 30 is cured under.

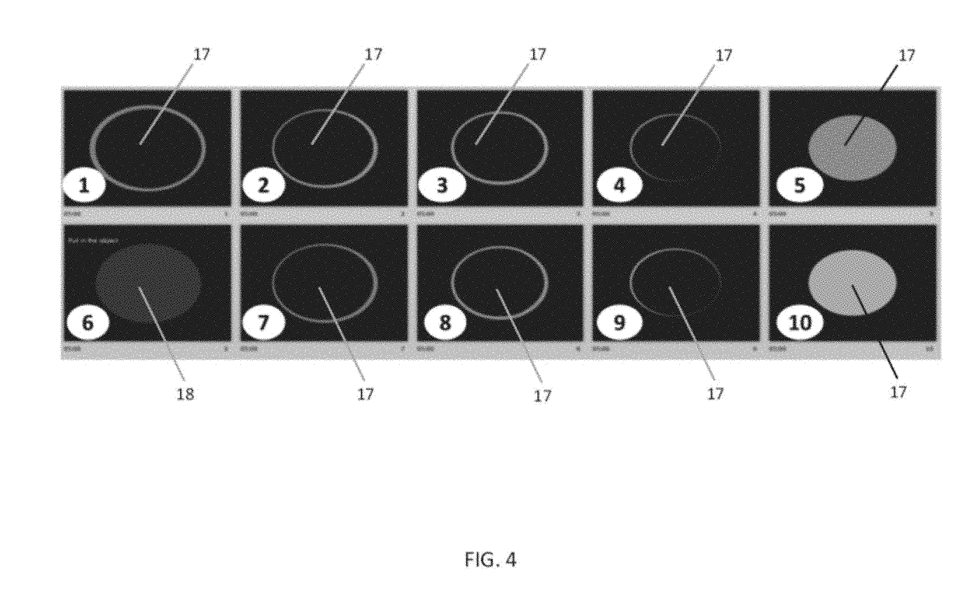

With reference to FIG. 4, there is shown an example embodiment showing the steps for printing a penholder 80 designed in the example embodiment illustrated in FIGS. 3(A), 3(B), 3(C), 3(D), 3(E), 3(F), and 3(H). In this example embodiment, a plurality of slides 17 (ten slides in this example) are exported from the computer 40 and subsequently projected under the light source 20 towards the resin 30.

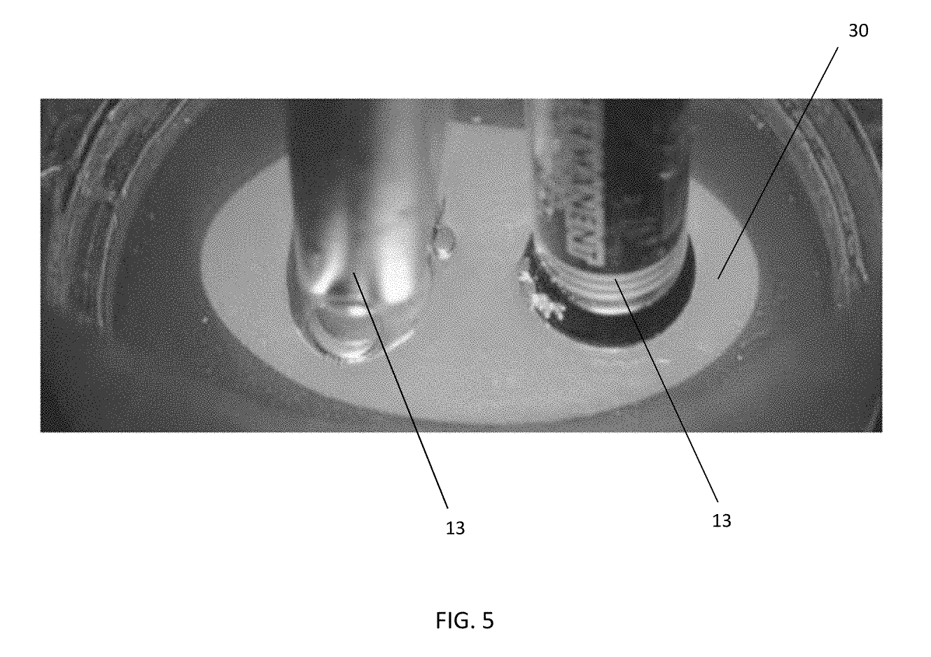

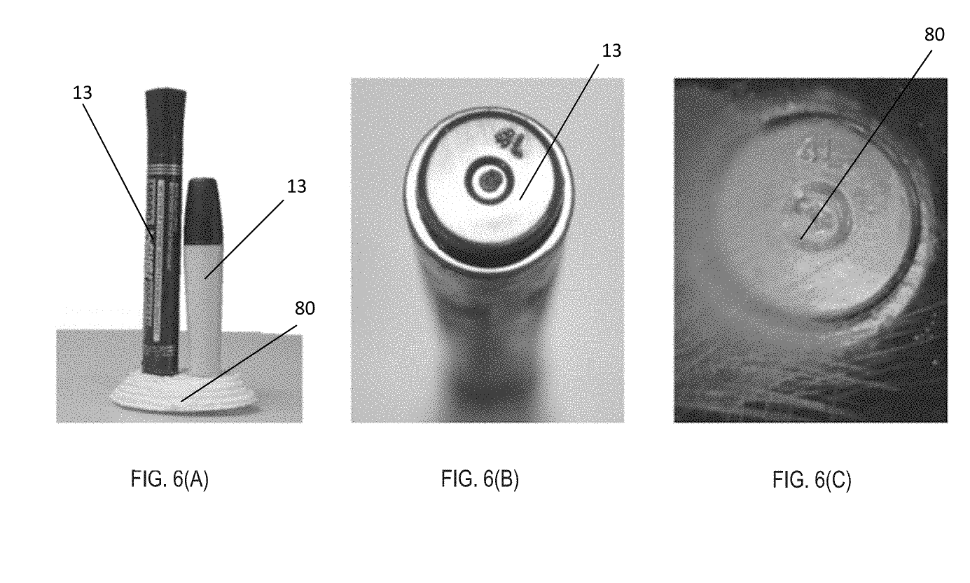

Optionally, after the first five slides 17 have been projected to cure the first few layers of the printed object 80 (not shown), the sixth slide 18 which corresponds to the sketched line 18 as depicted in FIG. 3(G) is exported and turned red by the computer 40 before projecting to the resin 30 to pause the printing process. Advantageously, the resin 30 would not be cured in the red light spectrum. Therefore, the user may place the pen 13 in the resin 30 and resume the remaining printing operations. The resin 30 is illuminated by the rest of the slides 17 under the light source 20 to complete the printing, as shown in FIG. 5. The detailed patterns on the bottom surface and the outer surface of the pen 13 are engraved and matched within the inner surface of the penholder 80, as shown in FIGS. 6(A), 6(B), and 6(C).

Advantageously, the thickness of each printed object 80 layer may be manipulated by the length of light exposure and the colour of the projected pattern under the light source 20, such that computer 40 may compute the colour of the object and the advance timing of the slides 17 based on the thickness specified by the user in the sketch interface 10.

Without wishing to be bound by theory, the inventors have discovered that thickness of the printed object 80 has a positive correlation with the RGB value of the projected colour and the increment of the length of the light exposure, and further devised that the thickness of each printed object layer (h) may be predicted by a mathematical polynomial model based on a particular setting of grayness of the projected colour (c) i.e. the projected colour, and projected duration (t) as below:

h=−0.00280t³−0.00125t²c+0.0000477tc²+0.000167c³+0.300t²+0.0125tc−0.00941c²−3.53t+1.66c−90.6 (1)
Residual Sum of Square: rss=9.91
h (mm): height of the printed model
t (minute): length of light exposure
c: grayness of the projected color (setting the RGB values equally)

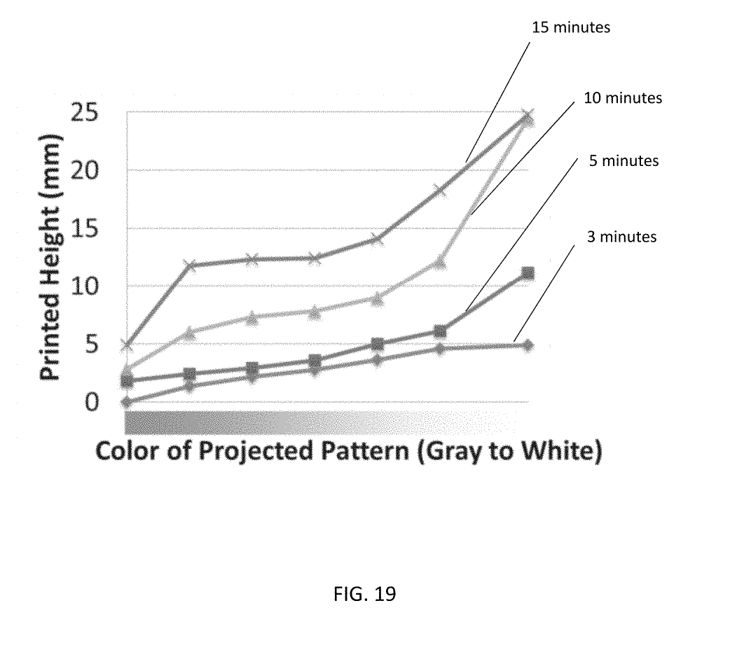

The inventors have further validated the above mathematical model and the printing module 200 of system 1 by comparing the resulting thickness of a plurality of cured resin 30 formed by slides 17 projected through light source 20 as shown in FIG. 19 with the designed thickness. Advantageously, the thickness of the printed object 80 achieved marginally low errors (rss=1.63) with reference to the desired thickness, and thus validated the polynomial model in equation 1 as shown in the result of Table 1 below.

TABLE 1
Validation of Equation 1

| | Calculated | Designed | Printed | |
|---|---|---|---|---|
| Time | Color | Height | Height | Error |
| (minute) | (R, G, B) | (mm) | (mm) | (mm) |
| 10 | (152, 152, 152) | 6 | 5.93 | 0.07 |
| 5 | (249, 249, 249) | 10 | 9.35 | 0.65 |
| 15 | (212, 212, 212) | 15 | 14.23 | 0.77 |
| 8 | (252, 252, 252) | 17 | 17.66 | 0.66 |
| 12 | (255, 255, 255) | 24 | 24.42 | 0.42 |

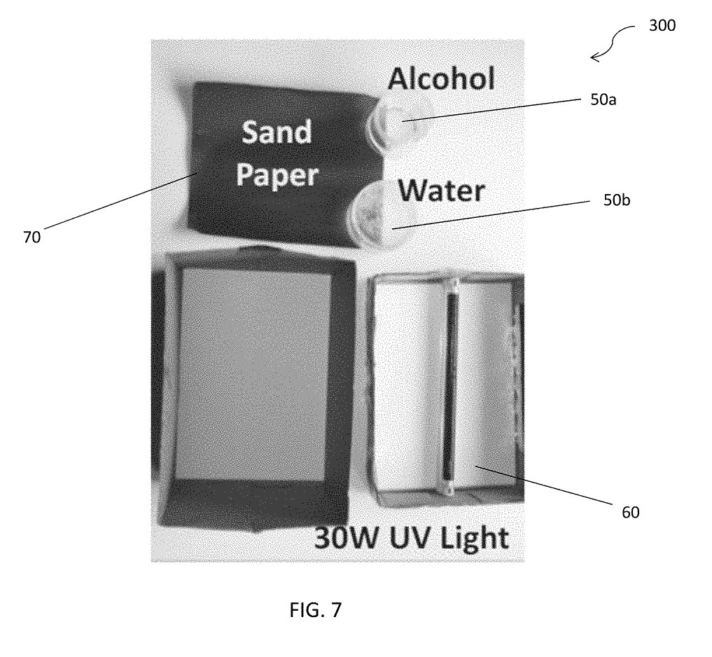

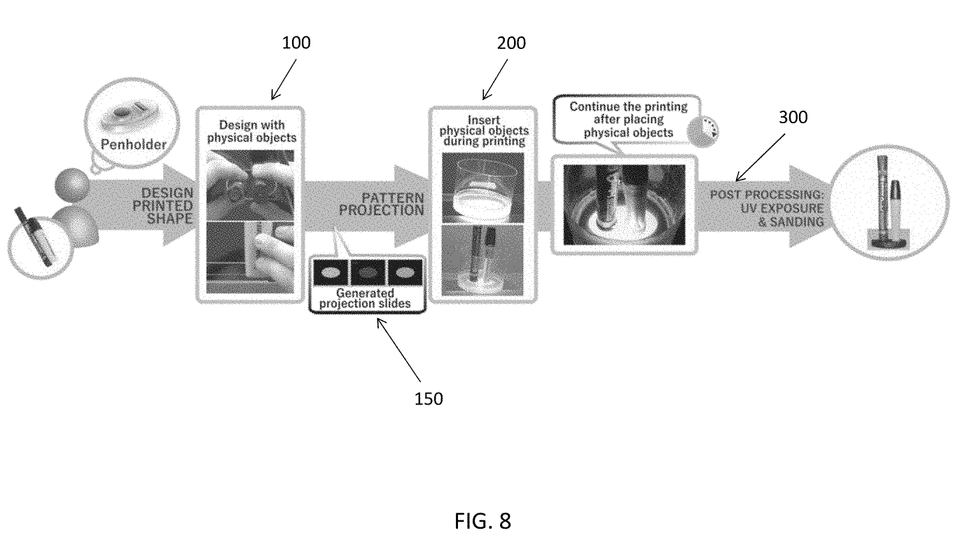

With reference to FIGS. 7 to 8, the system 1 may optionally comprise a post-possessing module 300 to post-process the obtained object 80 from printing module 200. The post-possessing module 30 may comprise a washing container 50 e.g. filling with alcohol 50a or water 50b, a UV light box 60 and a sand paper 70. The user gently peels the model off the container base 30 facilitated by flexible silicon 34, washes off the remaining liquid resin 30 on the printed object surface, applies UV exposure by putting the printed object in the UV light box 60, for example a 30W UV light tube for 3 minutes, and finally sands the surface of the printed object with the sand paper 70 to provide a fine finishing.

It will be appreciated by persons skilled in the art that the physical object 13 may be placed within the resin 30 at any time i.e. different stages of the printing process. Alternatively, when the physical object 13 is placed at the beginning of the printing process, a printed object 80 with a through hole fitting the contour of the physical object 13 may be formed.

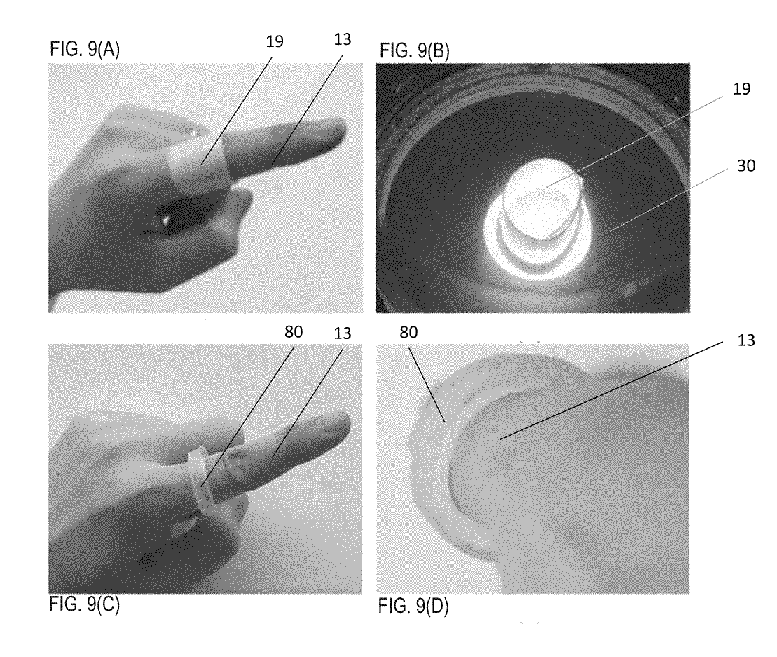

With reference to FIGS. 9(A), 9(B), 9(C), and 9(D), the physical object 13 may be a mold 19 of the real-life object 13. For example, a mold 19 of human finger 13 created with accessible materials such as paper, plastics or clay may be placed within the resin 30, thereby creating a well-fitting ring 80. For example, the user may make a ring 80 that matches his/her finger as shown in FIGS. 9(A), 9(B), 9(C), and 9(D). The user first create the wrapping 19 that fit the finger as shown in FIG. 9(A), designing the shape of the ring through the sketch interface 10, printing the ring with the wrapping 19 inserted into the resin 30 of the printing module 200 as shown in FIG. 9(B), and post-processing the printed ring 80 by the post-processing module 300.

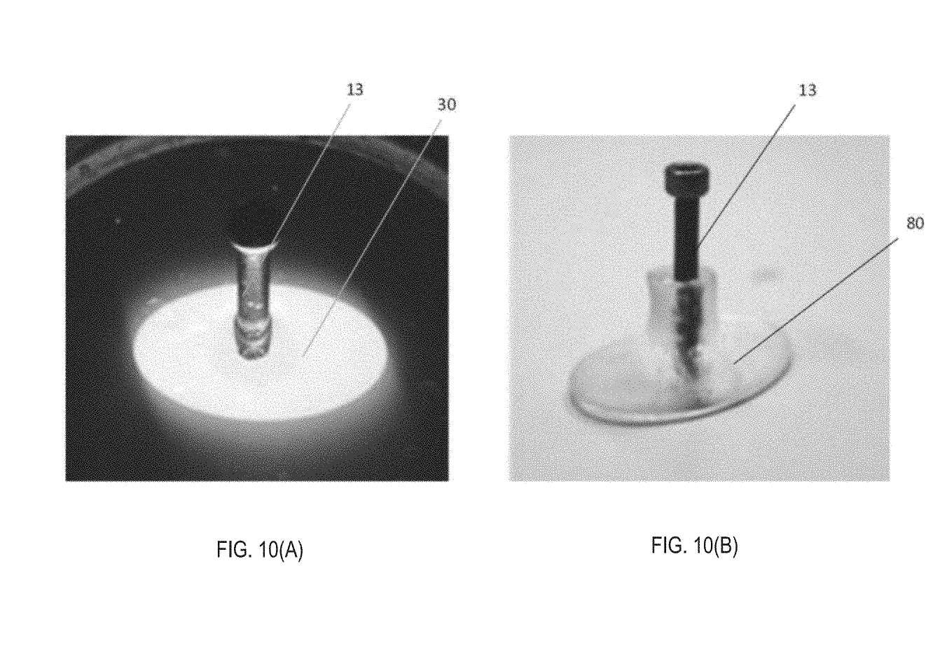

With reference to FIGS. 10(A) to 10(B), the physical object 13 may be an object with complex geometric structures or surfaces such as screw thread 13 or any other parts for industrial applications. The screw 13 is placed within the resin 30 as shown in FIG. 10(A), such that the resin 30 may be cured under the light source 20 around the screw 13 and thereby creating a printed object 80 with internal threads that fit the outer surface of the screw 13 as shown in FIG. 10(B). Advantageously, this embodiment is highly desirable, as the printed object 80 may fit the screw 13 without any measuring and modelling of the screw 13 or knowing the detailed specification of the screw 13.

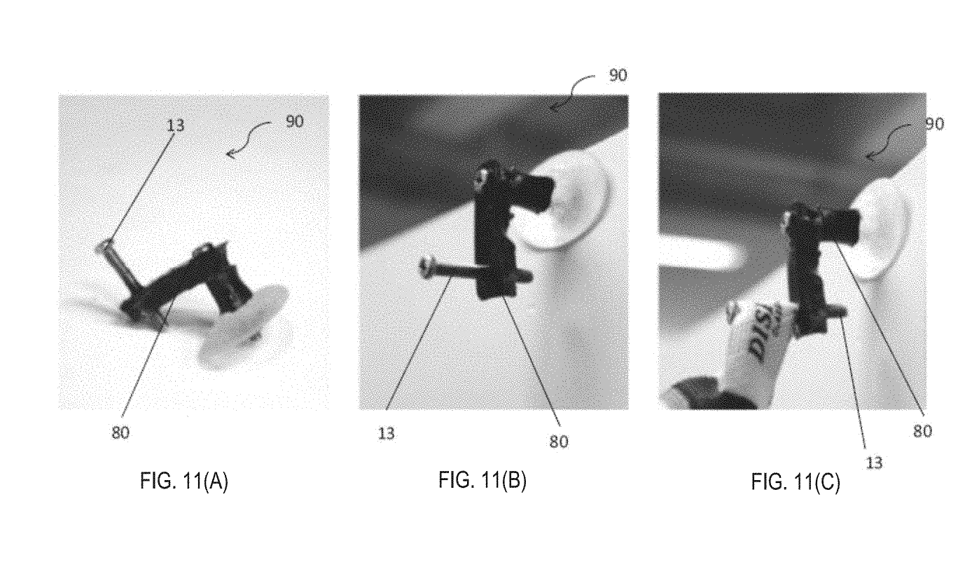

With reference to FIG. 11(A), the physical object 13 may be part of an assembled structure 90 comprising detailed original parts 13 such as screw threads, special screws, screw bolts and missing parts for fitting to these detailed parts. The user may print a tiny part 80 as a substitution of the missing parts for fitting to the original parts 13 of the assembled structure 90. For example, the printed part 80 may accommodate the screw threads and thereby resemble the assembled structure 90 such as a wall mounted hook for hanging clothes as shown in FIGS. 11(B) and 11(C).

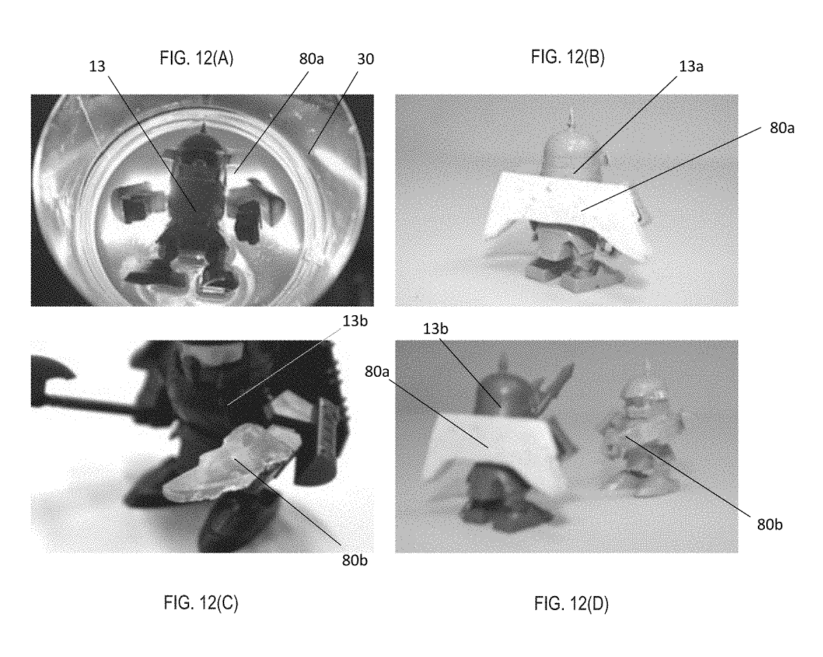

With reference to FIGS. 12(A), 12(B), 12(C), and 12(D), the physical object 13 may be a toy 13 or any other objects for personal entertainment. New part 80 for toy 13 may be designed in the sketch interface 10. The existing toy 13 may be placed in the resin 30 of the printing module 200 during printing as shown in FIG. 12(A), such that the printed objects 80, i.e. the new parts 80 may fit into the slots in the original toy 13 as shown in FIGS. 12(B) and 12(C). Advantageously, the inner surface of the printed parts 80a and 80b may be fitted to the outer surface of different toys 13a and 13b manufactured from the same company with the same standard as shown in FIG. 12(D).

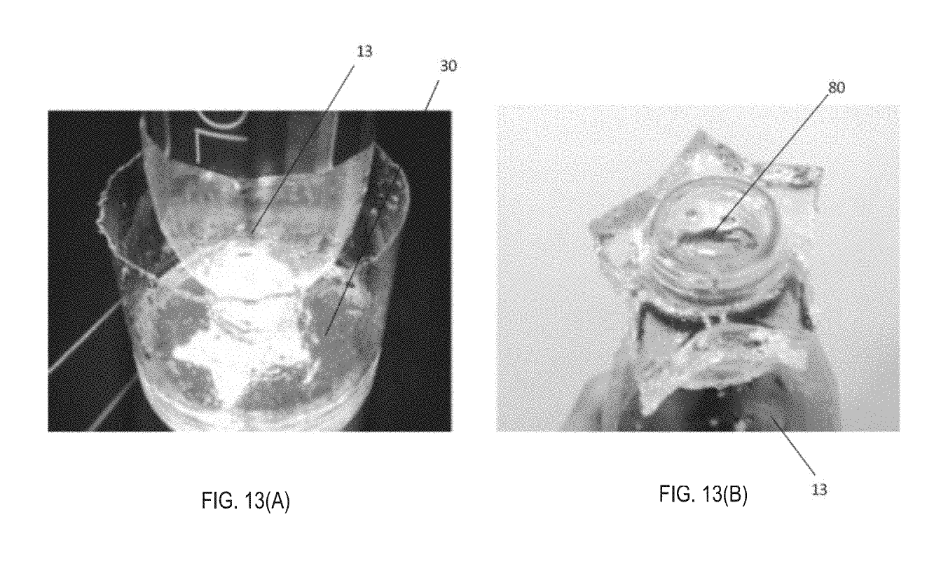

With reference to FIGS. 13(A) to 13(B), the physical object 13 may be a plastic bottle 13 without a cap. Different bottle caps may be sketched in the sketch interface 10 and printed through the printing module 200. In this example embodiment, the star-shaped printed cap 80 with internal threads that fit the outer surface of the bottle 13 opening is formed by placing the bottle 13 into the resin 30 during the printing process as shown in FIG. 13(A). The printed plastic bottle cap 80 may facilitates the reuse of plastic bottles, and also differentiate the bottle from other. In one example, the different caps may be used for creating different medicine bottles for vision-impaired person.

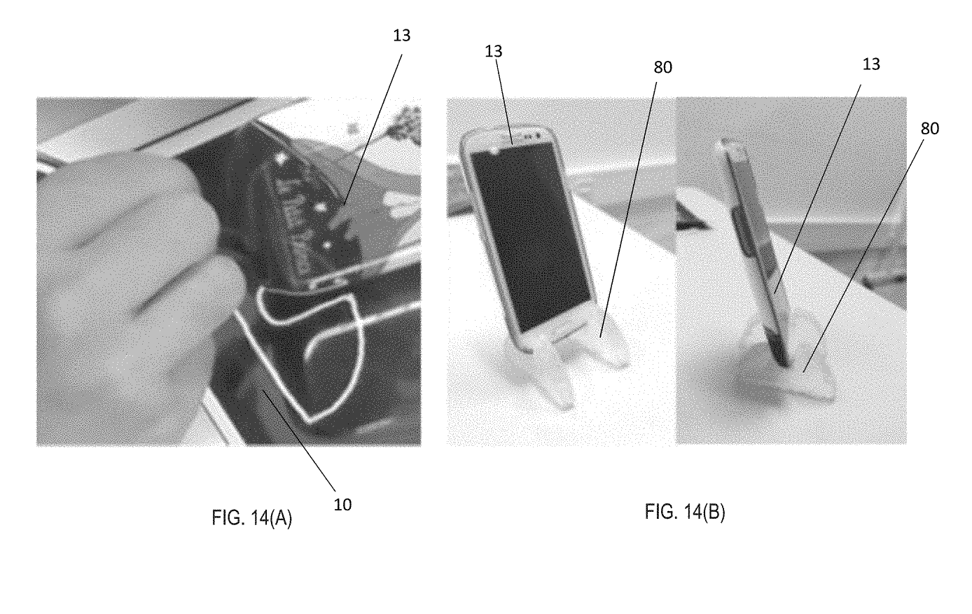

With reference to FIGS. 14(A) to 14(B), the physical object 13 may be a mobile phone 13. The shape of a stand is sketched in the sketch interface 10 as shown in FIG. 14(A). With the aiding of the mobile phone 13, the user may trace the edge of the phone 13 to ensure the slot of the printed stand 80 fit the size of the mobile phone 13 well as shown in FIG. 14(B).

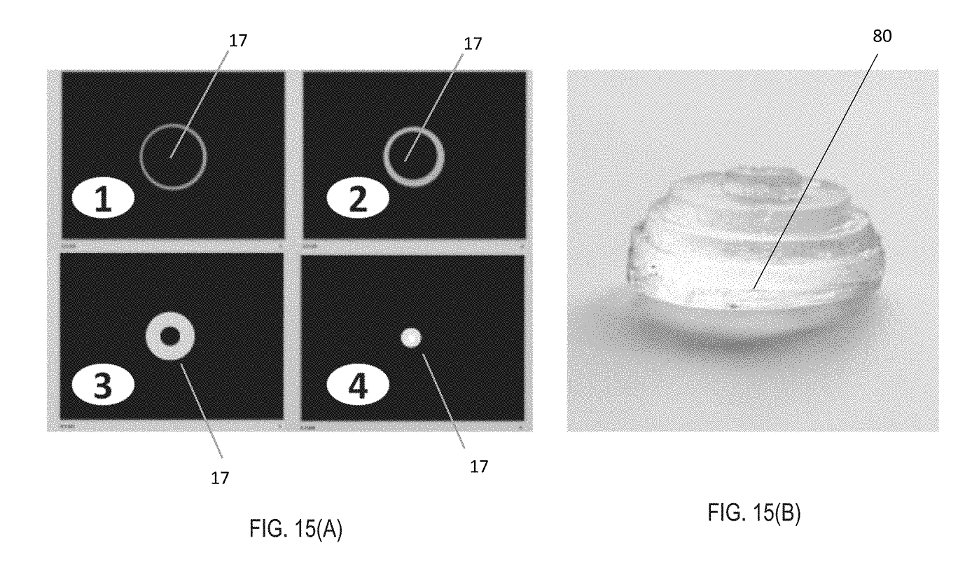

It will be appreciated by persons skilled in the art that the printed object 80 may be a solid object without slots or opening for receiving any physical objects. For example, the slides 17 may be projected under the light source 20 to form a solid half sphere 80 as shown in FIGS. 15(A) and 15(B).

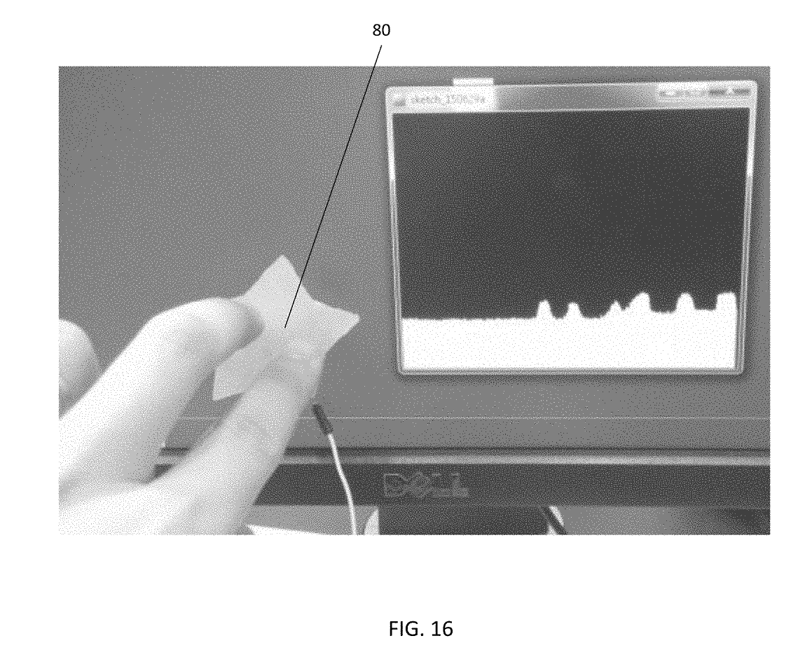

In one example embodiment, the photo-reactive resin 30 filled within the container 32 may be mixed with conductive gel 36, thereby forming a mixture 38 for creating conductive printed object 80 that can be used as capacitance-based touch sensors as shown in FIG. 16. Selectively, the conductive gal 36 may be any gels widely used in cosmetic and medical treatments.

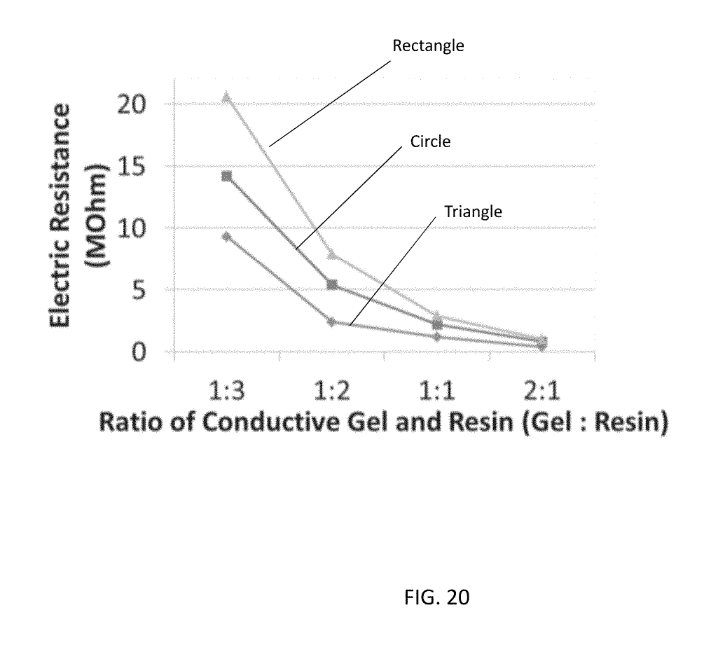

Without wishing to be bound by theory, the inventors have discovered that the electric resistance is significantly reduced with the increase in portion of the conductive gel in the mixture 38, and also varies among the triangle, circle and rectangular shape as shown in FIG. 20. The ratio of conductive gel 36 to photo-reactive resin 30 may be 1:3, 1:2, 1:1 or 2:1 etc., and more preferably to be 1:2 as the surface roughness increases along with the increment of conductive gel 36 in the mixture 38 to provide stronger effect on light scattering.

In one example embodiment, the conductivity and the touching sensitivity may be manipulated by the shape of the printed object 80, thereby assigning a unique touch ID to each of the printed objects 80. Advantageously, the printed object 80 may detect the number of touch points, thereby facilitating the design of multi-touch interaction.

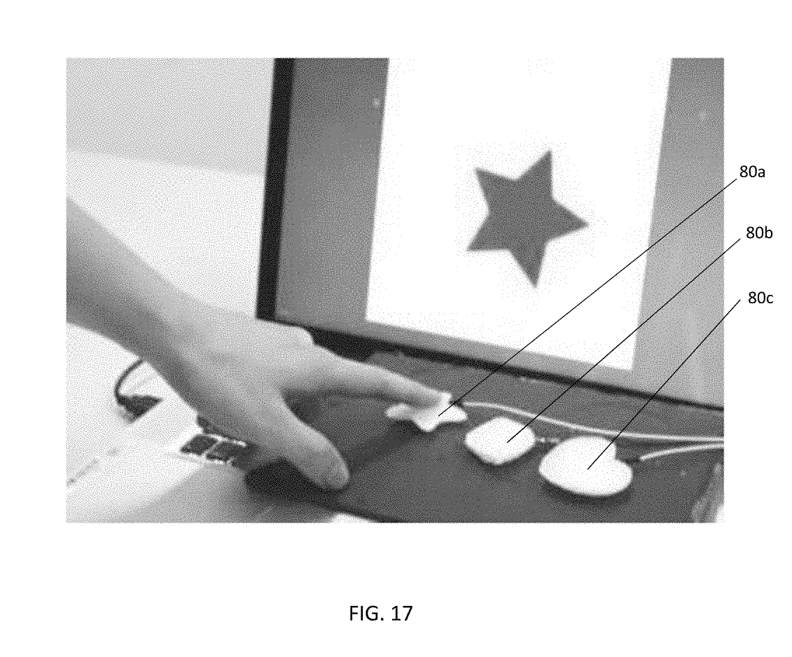

With reference to FIG. 17, the various electric resistances of the printed object 80 from the mixture 38 may provide interactivity, such that objects 80 with different resistances may be created in different shapes. Advantageously, the three conductive objects 80a, 80b and 80c in this embodiment, may be connected to the normal capacitive touch-sensing circuit to form different touch sensor circuits.

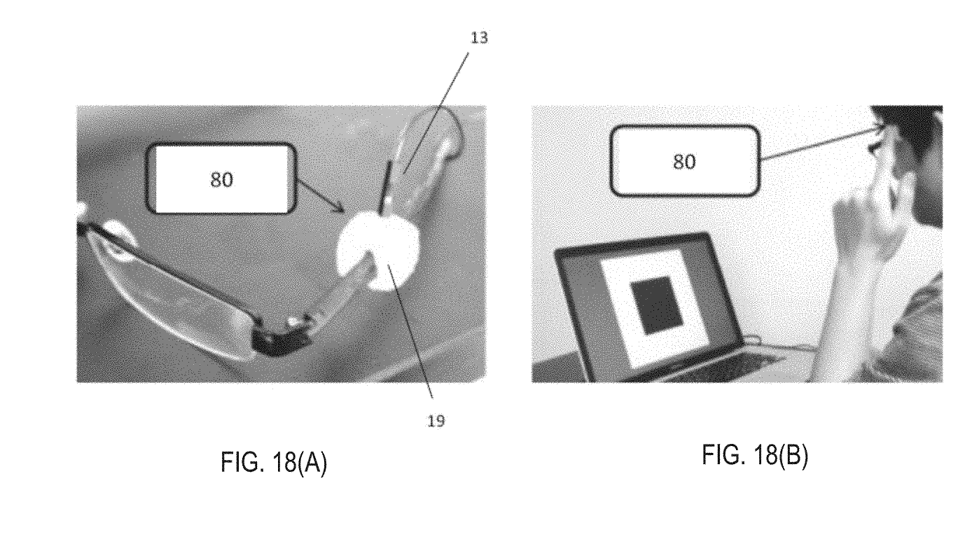

With reference to FIGS. 18(A) and 18(B), the user may create a tiny accessory for his glasses using the mixture 38 of photo-reactive resin 30 and conductive gel 36, for turning his glasses into a pair of glasses with touch-sensitive capabilities. In this example embodiment, the user may use sketch the shape of the sensor in the sketch interface 10 with the aiding of the glasses 13. A plastic sheet 19 is then wrapped around the earpiece of the glasses 13 and inserted into the mixture 38 for printing a touch sensor 80. The formed touch sensor 80 may be fitted and attachable to the glasses 13, thereby developing an interactive demo. Advantageously, the present invention may shorten the iteration of prototyping for designers by allowing the designers to create a nice proof of concept in the first iteration without any tedious modelling and printing processes.

It will be appreciated by person skilled in the art that the present invention may be applied in mechanical fabrication, toy design, wearable design, interactive system prototyping, bioengineering, biomechanics and healthcare etc.

It will be appreciated by persons skilled in the art that the present invention may also be applied in high-precision assembly mechanisms fabrication, including non-permanent assembly such as screw threads in valve structures, and permanent assembly such as shaft-hole sockets and pipes without requiring any high-end modelling tools.

It will be appreciated by persons skilled in the art that the present invention may be further applied to prosthesis for delivering a printed part that perfectly fit the bodies of disabled patients.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method for printing an object comprising the steps of:
displaying a two-dimensional representation within a two-dimensional space, wherein the two-dimensional representation is arranged to represent a two-dimensional view of a three-dimensional object within the two-dimensional space;
transforming the two-dimensional representation into a plurality of two-dimensional expressions arranged to individually represent a portion of the three-dimensional object;
forming the three-dimensional object from a fluid medium arranged to transform its physical state in response to a manipulated illumination exposed thereto, wherein the manipulated illumination exposed to the fluid medium is associated with the plurality of two-dimensional expressions disposed therebetween, and with the inner surface of the printed three-dimensional object being arranged to match the outer surface of a real-world object inserted therein.

2. The method according to claim 1, wherein each of the represented portions of the three-dimensional object are evenly spaced along at least one of the X, Y and Z axis of the three-dimensional object.

3. The method according to claim 1, wherein the two-dimensional representation includes a sketch displayed on a design interface.

4. The method according to claim 3, wherein the sketch includes at least one sketched line.

5. The method according to claim 4, wherein the sketch further includes at least one additional sketched line associated with the inserting location of the real-world object.

6. The method according to claim 1, wherein the plurality of two-dimensional expressions includes a plurality of slides.

7. The method according to claim 3, further comprises the step of transforming the sketch into a plurality of slides.

8. The method according to claim 7, further comprises the step of shining the plurality of slides to cure a photo-reactive resin thereby forming the three-dimensional object layer by layer.

9. The method according to claim 8, wherein the plurality of slides are shined in sequence by a light source to cure the photo-reactive resin gradually.

10. The method according to claim 8, wherein the thickness of the three-dimensional object layer is manipulated by the light intensity of the light source, the length of exposure under the light source and/or the colour of the slides.

11. The method according to claim 8, wherein an additional slide is shined by a projector to pause the curing of the photo-reactive resin.

12. The method according to claim 8, further comprises the step of inserting the real-world object or a mold of the real-world object into the photo-reactive resin during the step of printing.

13. The method according to claim 11, wherein the real-world object or the mold of the real-world object is inserted into the photo-reactive resin when the curing is paused.

14. The method according to claim 8, wherein the photo-reactive resin includes flexible silicon arranged to facilitate the removal of the printed three-dimensional object.

15. The method according to claim 1, further comprises the step of post-processing the printed three-dimensional object.

16. The method according to claim 15, wherein the printed three-dimensional object is arranged to undergo a surface treatment.

17. The method according to claim 16, wherein the surface treatment includes UV exposure and/or sanding.

18. The method according to claim 8, further comprises the step of mixing the photo-reactive resin with conductive gel prior to the shining step such that the formed three-dimensional object is conductive.

19. The method according to claim 18, wherein the conductivity and touch sensitivity of the conductive three-dimensional object is associated with the ratio of conductive gel to photo-reactive resin, and/or the shape of the object.

20. The method according to claim 1, wherein the real-world object includes a complex geometric structure.

21. A system for printing an object, comprising:
a display module arranged to display a two-dimensional representation within a two-dimensional space, wherein the two-dimensional representation is arranged to represent a two-dimensional view of a three-dimensional object within the two-dimensional space;
a processing module arranged to transform the two-dimensional representation into a plurality of two-dimensional expressions arranged to individually represent a portion of the three-dimensional object;
a printing module arranged to form the three-dimensional object from a fluid medium arranged to transform its physical state in response to a manipulated illumination exposed thereto, wherein the manipulated illumination exposed to the fluid medium is associated with the plurality of two-dimensional expressions disposed therebetween, and with the inner surface of the printed three-dimensional object being arranged to match the outer surface of a real-world object inserted therein.

22. The system according to claim 1, wherein each of the represented portions of the three-dimensional object are evenly spaced along at least one of the X, Y and Z axis of the three-dimensional object.

23. The system according to claim 21, wherein the two-dimensional representation includes a sketch displayed on a design interface of the display module.

24. The system according to claim 23, wherein the sketch includes at least one sketched line.

25. The system according to claim 24, wherein the sketch further includes at least one additional sketched line associated with the inserting location of the real-world object.

26. The system according to claim 21, wherein the plurality of two-dimensional expressions includes a plurality of slides.

27. The system according to claim 23, wherein the processing module transforms the sketch into a plurality of slides.

28. The system according to claim 27, wherein the plurality of slides are shined to cure a photo-reactive resin thereby forming the three-dimensional object layer by layer.

29. The system according to claim 28, wherein the plurality of slides are shined in sequence by a light source to cure the photo-reactive resin gradually.

30. The system according to claim 28, wherein the thickness of the three-dimensional object layer is manipulated by the light intensity of the light source, the length of exposure under the light source and/or the colour of the slides.

31. The system according to claim 28, wherein an additional slide is shined by a projector to pause the curing of the photo-reactive resin.

32. The system according to claim 28, wherein the real-world object or a mold of the real-world object is inserted into the photo-reactive resin during the printing.

33. The system according to claim 31, wherein the real-world object or the mold of the real-world object is inserted into the photo-reactive resin when the curing is paused.

34. The system according to claim 28, wherein the photo-reactive resin includes flexible silicon arranged to facilitate the removal of the printed three-dimensional object.

35. The system according to claim 21, the printed three-dimensional object is further post-processed.

36. The system according to claim 35, wherein the printed three-dimensional object is arranged to undergo a surface treatment.

37. The system according to claim 36, wherein the surface treatment includes UV exposure and/or sanding.

38. The system according to claim 28, wherein the photo-reactive resin is mixed with conductive gel prior to shining such that the formed three-dimensional object is conductive.

39. The system according to claim 38, wherein the conductivity and touch sensitivity of the conductive three-dimensional object is associated with the ratio of conductive gel to photo-reactive resin, and/or the shape of the object.

40. The system according to claim 21, wherein the real-world object includes a complex geometric structure.
